(19) United States
(12) Patent Application Publication
(10) Pub. No.: US 2023/0329257 A1
(43) Pub. Date: Oct. 19, 2023

(54) Mass Production Prepacked Shawarma and Gyro

(71) Applicant: Hassan Alaa Khudhur Alkwthr, Los Angeles, CA (US)

(72) Inventor: Hassan Alaa Khudhur Alkwthr, Los Angeles, CA (US)

(21) Appl. No.: 17/722,362

(22) Filed: Apr. 17, 2022

(51) Int. Cl. A23B 4/07

(52) U.S. Cl. CPC A23B 4/07

(57) ABSTRACT

The innovation is a method for manufacturing and storing ready-to-eat shawarmas for mass production. Aspects of the present invention mainly pertain to sequential phases as ways of cooking and preserving Shawarma. Shawarma now require time to cook, and a walk-in client may only be served after placing an order.

Shawarma is prepared from thin cuts of seasoned marinated lamb, mutton, veal, beef, chicken, or turkey. The slices are stacked on a skewer about 60 cm (20 in) high. Pieces of fat may be added to the stack to provide extra juiciness and flavor. A motorized spit steadily rotates the stack of meat in front of an electric or gas-fired heating source, roasting the outer layer continually. Shavings are cut off the rotating stack for serving, customarily with a long flat knife.

The method includes a cutting mechanism, a packaging and sealing mechanism, a storage mechanism, a freezing mechanism, a defrosting mechanism at a prescribed temperature, an instant preparation mechanism and meal assembly mechanism.

The preceding disclosure includes a separate innovation. Cutting, packaging, suitable organizing and labeling, freezing, thawing, defrosting, instant preparation, and immediate serving are all part of the procedure.

This one-of-a-kind approach must be strictly followed in order to obtain the desired outcomes.

### SUMMARY OF INVENTION

The invention is a method of preserving the shawarma once it has been prepared;
i. For a much longer periods of time
ii. In compliance with highest health and safety statutory standards.

The method involves
i. packing the shawarma in sealed bags hence preserving it from bacteria as well as other microorganisms
ii. Then freezing it and lastly,
iii. When needed, bringing it to the prescribed temperature before serving to the customers.

### Specification without Markings

1. The traditional method of creating Shawarma is time-consuming and defies the concept of quick preparation. It is made with thin slices of seasoned marinated lamb, mutton, calf, cattle, chicken, or turkey. The slices are piled 60 cm (20 in) high on a skewer. To add more juiciness and taste, add pieces of lard to the stack. A motorized spit spins the stack of meat in front of an electric or gas-fired heating source, continuously roasting the outer layer.

2. As a result, shawarma can only be cooked on demand, rather than on occasion for a walk-in consumer who wants to eat shawarma whenever they want. This innovation is about quick shawarma preparation.

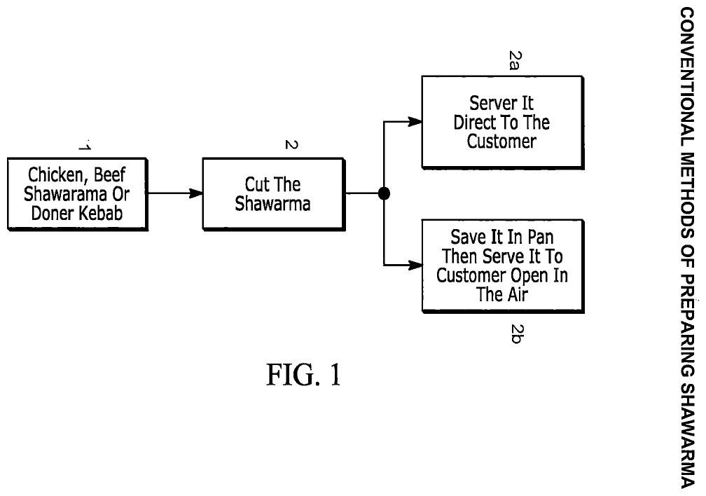

3. Referring now to the drawings, FIG. 1 particularly, the conventional time-consuming method of preparing Shawarma is outlined and the various incidental steps.

4. This invention relates specifically to preservation, which will be accomplished by preparing shawarma, packing the ready-to-eat shawarma in sealed bags out of reach of microorganisms, vacuuming the said bags, freezing it, and finally, bringing it to the prescribed temperature before serving to customers.

5. According to one aspect of the present invention, there is provided a chronological method to be strictly adhered to with regards to a cutting mechanism, a packaging and sealing mechanism, a storage mechanism, a freezing mechanism, a defrosting mechanism at a prescribed temperature, an instant preparation mechanism and meal assembly mechanism.

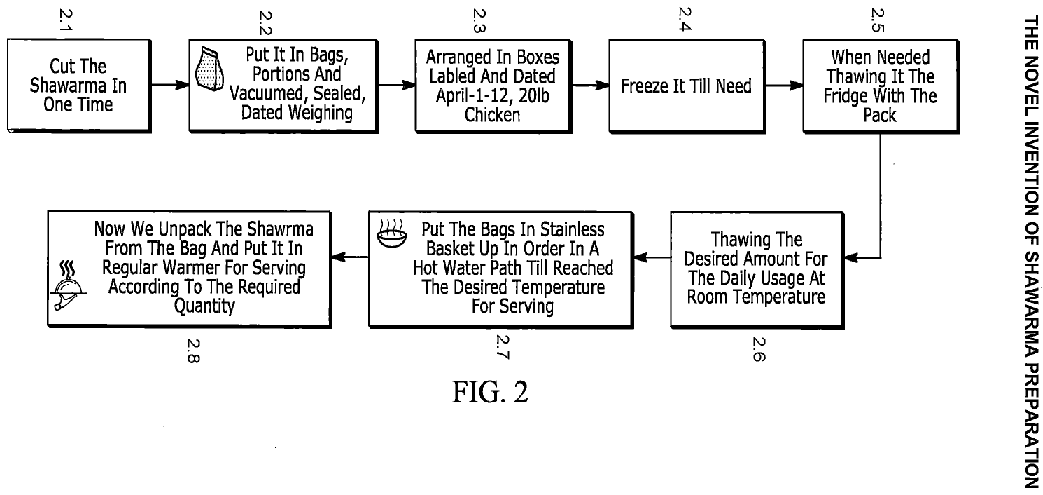

6. For a better understanding of the present invention, and to show how the same may be put into effect, reference will now be made, by way of example, to the accompanying drawings, in which; FIG. 2 is an exploded perspective view of shawarma preservation in accordance with the present invention.

7. FIG. 2 is the prescribed chronological method to be strictly adhered to.

8. As shown in FIGS. 2,
a cutting mechanism
FIG. 2.1 shows how to cut the Shawarma
a packaging and sealing mechanism,
FIG. 2.2 recommends the appropriate way of packing the Shawarma
a storage mechanism and sorting out mechanism
FIG. 2.3 recommends the appropriate way of sorting out the packed Shawarma
a freezing mechanism,
FIG. 2.4 recommends the appropriate length of refrigirating the packed Shawarma
a defrosting mechanism at a prescribed temperature,
FIGS. 2.5 and 2.6 recommends the appropriate way to thawl the packed Shawarma
an instant preparation mechanism and meal assembly mechanism.
FIGS. 2.7 and 2.8 recommends the appropriate way to instantly prepare the packed, preserved and defrosted Shawarma

9. A technique of making instant Shawarma has been described herein above with reference to the accompanying drawings in compliance with 37 CFR 1.52, 1.121(b)(3) and 1.25.

10. Any novel and new feature or combination of features have been described herein.

1. The method of storing prepared shawarmas is completely original in the targeted field.

2. This process is clearly recognized from the standard practice in the shawarma-making industry.

3. This approach is intended to aid in the bulk production of prepared shawarmas and their preservation in accordance with food and health safety regulations.

4. Patenting this technique comprised of chronological steps would grant the inventor and proprietor exclusive rights to prohibit anyone from making, using, or selling the protected innovation by passing it off as their own.

5. This technique of instant Shawarma preparation in line with healthy and safety standards is;
Novel,
Nonobvious
Involves an inventive step
Industrially applicable

6. A method of cutting in appropriate portions, proper organization and labeling, freezing, thawing, defrosting, quick preparation, and immediate serving in record time.

7. The method of preparing bulk packed ready to eat sliced meat further comprising the step of:
Freezing and defrosting mechanism at a prescribed temperature.

8. The method of providing sliced meat of, further comprising the step of:
Guidelines on packaging ready to eat shawarma as prescribed which is in compliance with health and safety statutory requirements.

9. A method of preserving that guarantees a lengthy shelf life for ready to eat shawarma and gyro meals comprising:
Cutting the cooked shawarma in accordance with the recommendations
Putting ready-made shawarma in pouches that have been sanitized, sealed, and hermetically sealed to keep harmful bacteria out in accordance with health and safety regulations.
Vacuuming the pouches that have been sterilized and contain shawarma.
Labeling the pouches with the weight as well as the date the packaging was completed
Placing the specified packed pouches in the boxes that are arranged according to the dates they were prepared
Freezing the shawarma in pouches at prescribed temperature
Thawing the necessary number of shawarma bags for daily usage are the steps.

10. The method of instant preparation of the packed ready to eat shawarma, by bringing the shawarma up to the proper and specified temperature so that it may be served to the consumer further comprising the step of:
Putting the shawarma bags in a stainless-steel basket and placing it in a water bath at the right temperature
Letting the bags sit in the water until they reach the required temperature
After achieving the desired temperature on account of being submerged in hot water, the bags are removed from the stainless steel basket and placed in a conventional warmer water before being served to customers in required and requested quantities.
